(19) United States
(12) Patent Application Publication
(10) Pub. No.: US 2011/0205129 A1
(43) Pub. Date: Aug. 25, 2011

(54) MOBILE WIRELESS EQUIPMENT

(75) Inventors: Masashi Koshi, Ishikawa (JP); Kouta Aoki, Kanagawa (JP)

(73) Assignee: PANASONIC CORPORATION, Kadoma-shi, Osaka (JP)

(21) Appl. No.: 13/126,077

(22) PCT Filed: Oct. 20, 2009
(86) PCT No.: PCT/JP2009/005500

§ 371 Date: Apr. 26, 2011

(30) Foreign Application Priority Data
Oct. 30, 2008 (JP) 2008-280332

(51) Int. Cl. H01Q 1/24; H01Q 1/50

(52) U.S. Cl. 343/702

(57) ABSTRACT

Disclosed is mobile wireless equipment wherein degradation of antenna performance in a condition with the casing closed can be prevented. In this mobile wireless equipment, a first casing (101) is provided with a circuit board (111). A second casing (102) is provided with a circuit board (112). A first hinge (104) is conductive and freely rotatably links the first casing (101) and the second casing (102), and is electrically connected with a power supply unit (121) by way of an antenna element (701). A second hinge (105) is conductive and freely rotatably links the first casing (101) and the second casing (102). A wireless circuit (113) is provided on the circuit board (112). The power supply unit (121) is electrically connected with the wireless circuit (113) and supplies power to the antenna element (701).

### TECHNICAL FIELD

The present invention particularly relates to a mobile radio device having cases that can be opened and closed.

### BACKGROUND ART

A mobile radio device in which a ground pattern on a circuit substrate that is provided in a metallic frame mounted in an upper case or in the upper case, a hinge section, and a ground pattern on a circuit substrate that is provided in a lower case function as a dipole antenna has been known heretofore (see, for example, patent literature 1).

### CITATION LIST

### Patent Literature

PTL 1: Japanese Patent Application Laid-Open N. 2005-6096

### SUMMARY OF INVENTION

### Technical Problem

However, with the mobile radio device of patent literature 1, in its closed state in which an upper case and a lower case overlap each other, the metallic frame of the upper case and the circuit substrate of the lower case are placed close to each other, and the current that flows in the metallic frame and the current that flows in the circuit substrate flow in directions to cancel each other, resulting in deteriorated dipole antenna performance.

As a method of solving this problem, a study is underway to use a hinge section to connect an upper case and a lower case in a rotatable fashion as a monopole antenna element, and, by this means, use the above-mentioned dipole antenna in an open state and use a monopole antenna in a closed state.

However, to use this hinge section as a monopole antenna element, the hinge section, having to have certain strength to function as a rotation axis to allow the upper case and the lower case to rotate, is difficult to miniaturize. As a result of this, the hinge section approaches a ground section in the lower case and a ground section in the upper case close, and, in a state where these cases are closed, deterioration of antenna performance becomes a problem.

The present invention has been made in view of the above, and it is therefore an object of the present invention to provide a mobile radio device that can prevent antenna performance from deteriorating in a state in which cases are closed.

### Solution to Problem

A mobile radio device according to the present invention employs a configuration having: a first case having a first circuit substrate; a second case having a second circuit substrate; a hinge section that is electrically conductive and that connects the first case and the second case in a rotatable fashion; an antenna element; a radio circuit that is provided in the first circuit substrate or in the second circuit substrate; and a power feed section that is electrically connected with the radio circuit and that feeds power to the antenna element, and, in this mobile radio device, the hinge section is electrically connected with the power feed section via the antenna element.

### Advantageous Effects of Invention

With the present invention, it is possible to prevent antenna performance from deteriorating in a state in which cases are closed.

### BRIEF DESCRIPTION OF DRAWINGS

FIG. 1 is plan view showing a mobile radio device according to embodiment 1 of the present invention;

FIG. 2 is plan view showing a mobile radio device according to embodiment 1 of the present invention;

FIG. 3 is plan view showing a mobile radio device according to embodiment 1 of the present invention;

FIG. 4 is a perspective view showing principal parts of a mobile radio device according to embodiment 1 of the present invention;

FIG. 5 is plan view showing a mobile radio device according to embodiment 2 of the present invention;

FIG. 6 is a perspective view showing principal parts of a mobile radio device according to embodiment 2 of the present invention;

FIG. 7 is plan view showing a mobile radio device according to embodiment 3 of the present invention;

FIG. 8 is a perspective view showing principal parts of a mobile radio device according to embodiment 3 of the present invention;

FIG. 9 provides another view of principal parts of a mobile radio device according to embodiment 3 of the present invention;

FIG. 10 is plan view showing a mobile radio device according to embodiment 4 of the present invention; and

FIG. 11 is plan view showing a mobile radio device according to embodiment 5 of the present invention.

### DESCRIPTION OF EMBODIMENTS

Now, embodiments of the present invention will be described in detail with reference to the accompanying drawings.

### Embodiment 1

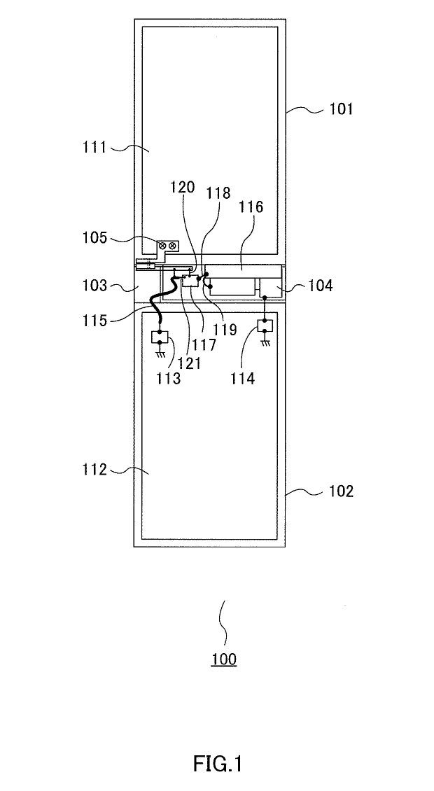

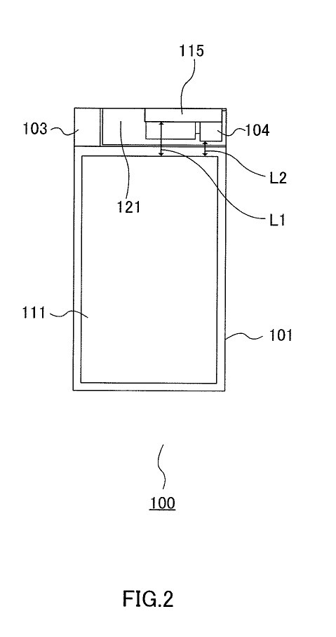

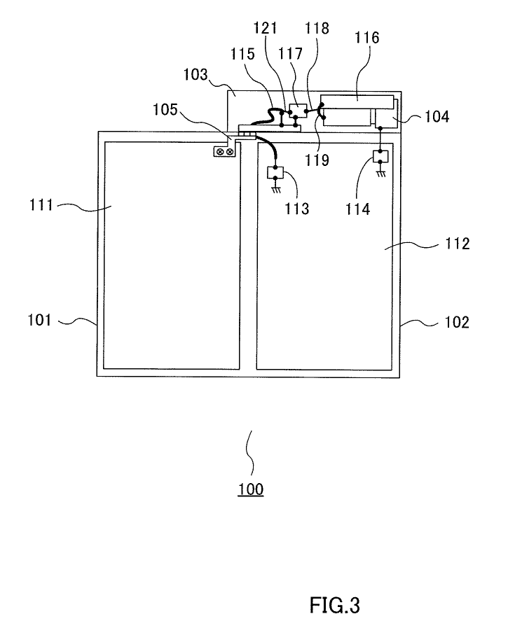

FIG. 1 to FIG. 3 shows plan views of mobile radio device 100 according to embodiment 1 of the present invention. FIG. 1 and FIG. 3 show mobile radio device 100 in an open state, and FIG. 2 shows mobile radio device 100 in a closed state.

Mobile radio device 100 has three cases: first case 101, second case 102, and third case 103. Also, first case 101, second case 102 and third case 103 are connected in a mutually rotatable fashion about first hinge section 104 as a rotation axis. Also, first case 101, second case 102 and third case 103 are connected in a mutually rotatable fashion about second hinge section 105 as a rotation axis.

Now, each component of mobile radio device 100 will be described in detail.

First case 101 has a rectangular shape on a plan view, and is rotatably connected with second case 102, via third case 103, by means of first hinge section 104 or second hinge section 105. Also, first case 101 has circuit substrate 111 inside. Also, first case 101 has a display surface (not shown) that is exposed to the outside and displays an image when mobile radio device 100 is open.

Second case 102 has a rectangular shape on a plan view, and is rotatably connected with first case 101, via third case 103, by means of first hinge section 104 or second hinge section 105. Also, first case 101 has an operation surface (not shown) that is exposed to the outside and is operated during a call and so on, when mobile radio device 100 is open. Second case 102 has circuit substrate 112 inside.

Third case 103 accommodates first hinge section 104 and part of second hinge section 105 inside. Also, third case 103 accommodates antenna element 116 and matching circuit 117 inside. Also, third case 103 accommodates part of coaxial wire 115 inside.

First hinge section 104 is formed of an electrically conductive material, and connects first case 101, second case 102 and third case 103 in a rotatable fashion, so as to switch from the open state shown in FIG. 1 to the closed state shown in FIG. 2, or from the closed state of FIG. 2 to the open state of FIG. 1. That is to say, first hinge section 104 connects first case 101, second case 102 and third case 103, in a rotatable fashion, along the long direction of first case 101 or second case 102 (encompassing the upward or downward directions in FIG. 1 to FIG. 3). First hinge section 104 is furthermore electrically connected with antenna element 116 and is also electrically connected with terminating end section 114.

Second hinge section 105 is formed of an electrically conductive material, and connects first case 101, second case 102 and third case 103 in a rotatable fashion, so as to switch from the open state shown in FIG. 2 to the closed state shown in FIG. 3, or from the closed state of FIG. 2 to the open state of FIG. 3. That is to say, second hinge section 105 connects first case 101, second case 102 and third case 103, in a rotatable fashion, along a direction perpendicular to the long direction (encompassing the left and right directions in FIG. 1 to FIG. 3). Also, second hinge section 105 is electrically connected with a ground section of matching circuit 117, via connecting section 120, and is also electrically connected with a ground section of circuit substrate 111, via a terminating circuit (not shown in FIG. 1 to FIG. 3). Second hinge section 105 is designed to be able to rotate with first case 101 when rotating first case 101 about first hinge section 104 as a rotation axis.

Circuit substrate 111 has an electrically conductive circuit pattern (not shown) on a flat surface part, and has a ground section nearly over the entire surface (now shown). Also, circuit substrate 111 is electrically connected with second hinge section 105. The ground section is formed by, for example, printing a ground pattern on circuit substrate 111.

Circuit substrate 112 has an electrically conductive circuit pattern (not shown) on a flat surface part, and has a ground section nearly over the entire surface (now shown). Circuit substrate 112 has radio circuit 113 that is grounded to a ground section and terminating end section 114 that is grounded to a ground section. A ground section is formed by, for example, printing a ground pattern on circuit substrate 112.

Radio circuit 113 is electrically connected with coaxial wire 115. Also, radio circuit 113 performs receiving processing for a signal received by an antenna and performs transmitting processing for a signal to be transmitted from an antenna.

Terminating end section 114 is formed with a reactance element, and is electrically connected with a ground section of circuit substrate 112 and first hinge section 104.

Coaxial wire 115 is provided to supply power, and is electrically connected with radio circuit 113 and matching circuit 117. The ground of coaxial wire 115 is connected to a ground of circuit substrate 112 and hinge section 105.

Antenna element 116 is electrically connected with matching circuit 117 via connecting section 118. Also, antenna element 116 is electrically connected with first hinge section 104 by means of connecting section 119. Antenna element 116 is formed by, foe example, printing an electrically conductive pattern on an insulating substrate. Also, antenna element 116 is designed, for example, as an antenna of an approximately ¼ wavelength to oscillate in the 800 MHz band.

Matching circuit 117 is electrically connected with radio circuit 113 via coaxial wire 115, is electrically connected with antenna element 116 via connecting section 118, and matches impedance between antenna element 116 and radio circuit 113. Also, a ground section of matching circuit 117 is electrically connected with second hinge section 105 by means of connecting section 120.

In mobile radio device 100 having the above configuration, antenna element 116, first hinge section 104, terminating end section 114, and a ground section of circuit substrate 112 are mutually electrically connected, and antenna element 116 is fed power from power feed section 121. By this means, in both an open state and a closed state of mobile radio device 100, antenna element 116, first hinge section 104, terminating end section 114, and a ground section of circuit substrate 112 function as an antenna of an approximately ¼ wavelength. This antenna of an approximately ¼ wavelength configured this way resonates, for example, in the 800 MHz band.

Distance L1 between antenna element 116 and a ground section of circuit substrate 112 is made greater than distance L2 between first hinge section 104 and a ground section of circuit substrate 112 (L1>L2) (see FIG. 2). Also, distance L3 between antenna element 116 and a ground section of circuit substrate 111 is made greater than distance L4 between first hinge section 104 and a ground section of circuit substrate 111 (L3>L4) (not shown). By this means, mobile radio device 100 is able to alleviate the influence of a ground section of circuit substrate 112 and a ground section of circuit substrate 111 upon antenna element 116.

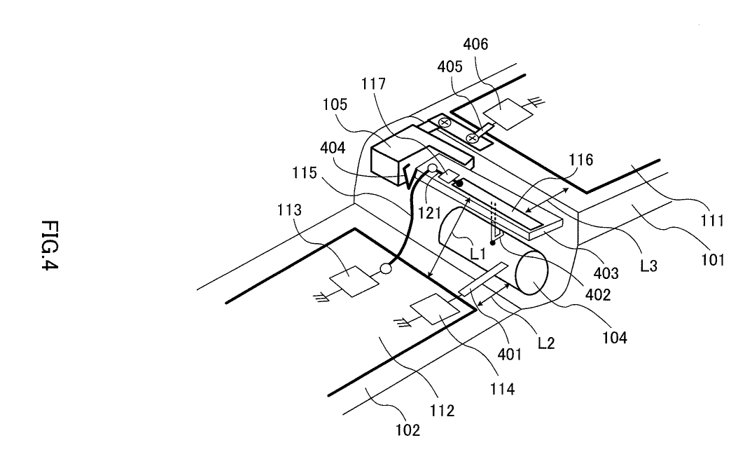

Next, the configuration of mobile radio device 100 will be described in more detail with reference to FIG. 4. FIG. 4 is a perspective view of mobile radio device 100. Parts in FIG. 4 that are the same as in FIG. 1 to FIG. 3 will be assigned the same reference numerals as in FIG. 1 to FIG. 3 and their explanations will be omitted.

Connecting section 401 is formed of an electrically conductive material and electrically connects first hinge section 104 and terminating end section 114.

Connecting section 402 is formed of an electrically conductive material that allows elastic deformation, and electrically connects antenna element 116 and first hinge section 104.

Substrate 403 is formed of an insulating material, and, using an electrically conductive material, antenna element 116 and matching circuit 117 are printed on an upper surface section. Also, substrate 403 has a throughhole (not shown) that penetrates from the upper surface section to the back surface section, and has a conductive layer in the inner wall part of the throughhole. This throughhole electrically connects antenna element 116 and connecting section 402.

Connecting section 404 is formed of an electrically conductive material that allows elastic deformation, and electrically connects a ground section of matching circuit 117 and second hinge section 105. Connecting section 404 is pressed against second hinge section 105, so that connection section 404 maintains an electrical connection with second hinge section 105 when second hinge section 105 rotates following the rotation of first case 101.

Connecting section 405 is formed of an electrically conductive material and electrically connects second hinge section 105 and terminating end section 406.

Terminating end section 406 is grounded to a ground section of circuit substrate 111 and terminates second hinge section 105 in a ground section of circuit substrate 111 via connection section 405. Also, terminating end section 406 is formed with a reactance element and electrically connects a ground section of circuit substrate 111 and second hinge section 105. In FIG. 1 and FIG. 3, terminating end section 406 is not shown for ease of explanation.

For example, antenna element 116 is placed such that distance L1 between antenna element 116 and a ground section of circuit substrate 112 is 12 mm and distance L3 between antenna element 116 and a ground section of circuit substrate 111 is 11 mm. First hinge section 104 has to function as a rotation axis and therefore cannot be miniaturized and cannot be provided in a place of poor balance, and, as a result, distance L2 between first hinge section 104 and a ground section of circuit substrate 112 has to be 5 mm, for example. Thus, with the present embodiment, antenna element 116 is placed such that L1>L2 and L3>L2. Also, although not shown in FIG. 4, antenna element 116 is placed such that distance L4 between first hinge section 104 and a ground section of circuit substrate 111 holds the relationship L1>L4 and L3>L4. By this means, compared to first hinge section 104, antenna element 116 is placed in a location substantially distant from both a ground section of circuit substrate 111 and a ground section of circuit substrate 112, so that it is possible to reduce the influence of both the ground section of circuit substrate 111 and the ground section of circuit substrate 112 upon antenna element 116.

In this way, with the present embodiment, by feeding power to a hinge section via an antenna element, it is possible to allow a ground section of a circuit substrate provided in the first case, a hinge section, and a ground section of a circuit substrate provided in a second case, as a dipole antenna, and achieve high antenna performance in an open state. Also, in addition to this, by feeding power to an antenna element provided in a distant location from a ground section of a circuit substrate, it is possible to prevent antenna performance from deteriorating in a closed sate. Also, with the present embodiment, for example, the length of an antenna element can be changed easily, so that, by adjusting an antenna element, it is possible to provide an antenna of better sensitivity.

### Embodiment 2

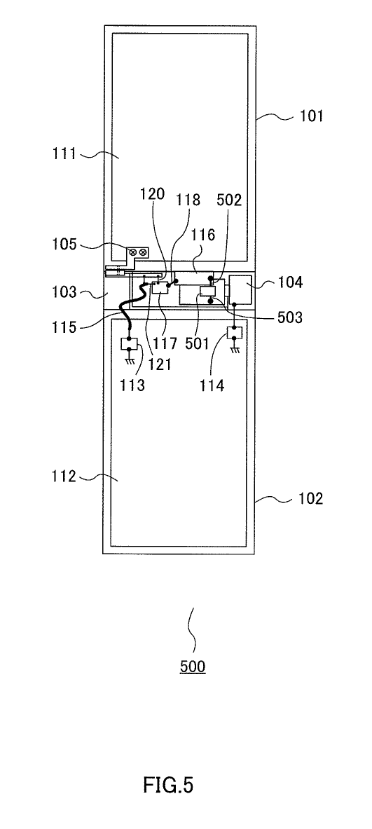

FIG. 5 is a plan view of mobile radio device 500 according to embodiment 2 of the present invention. FIG. 5 shows mobile radio device 500 in an open state.

Mobile radio device 500 shown in FIG. 5 adds filter 501, connecting section 502, and connecting section 503 to mobile radio device 100 of embodiment 1 shown in FIG. 1, except for connecting section 119. Parts in FIG. 5 that are the same as in FIG. 1 will be assigned the same reference numerals as in FIG. 1 and their explanations will be omitted. Also, with mobile radio device 500 according to the present embodiment, the closed state is the same as shown in FIG. 2 and the state in which first case 101 rotates in a direction perpendicular to the rotation direction in FIG. 5 and is open, is the same as in FIG. 3, and their explanations therefore will be omitted.

Third case 103 accommodates first hinge section 104 and part of second hinge section 105 inside. Also, third case 103 accommodates part of coaxial wire 115 inside.

Antenna element 116 is electrically connected with matching circuit 117 via connecting section 118. Also, antenna element 116 is fed power from power feed section 121 and functions as an antenna. Also, antenna element 116 is electrically connected with filter 501 by means of connecting section 502. Antenna element 116 is formed by, for example, printing an electrically conductive pattern on an insulating substrate. Antenna element 116 has, for example, an electrical length to resonate in the 2 GHz band.

Filter 501 is formed with a reactance element and is connected between antenna element 116 and first hinge section 104. Also, filter 501 is electrically connected with antenna element 116 by means of connecting section 502 and is also electrically connected with first hinge section 104 by means of connecting section 503, thereby electrically connecting first hinge section 104 and antenna element 116. Also, filter 501 has low impedance in the 800 MHz band and has high impedance in the 2 GHz band, thereby blocking the 2 GHz band. That is to say, when antenna element 116 resonates in the 2 GHz band, filter 501 prevents first hinge section 104 from functioning as an antenna. Also, filter 501, by designing filter 501 to have high impedance in other radio frequency bands as well, it is possible to allow filter 501 to secure isolation from antennas of other radio circuits. For example, it is possible to allow filter 501 to function as a filter to block the frequency band for digital television broadcast by having high impedance also in the 400 MHz band.

In mobile radio device 500 having the above configuration, antenna element 116, filter 501, first hinge section 104, terminating end section 114, and a ground section of circuit substrate 112 are electrically connected with each other, and antenna element 116 is fed power from power feed section 121. By this means, in a state in which mobile radio device 500 is open, antenna element 116, filter 501, first hinge section 104, terminating end section 114, and a ground section of circuit substrate 112 function as an antenna of an approximately ¼ wavelength. An antenna of an approximately ¼ wavelength configured this way resonates at a lower frequency (for example, in the 800 MHz band) than the 2 GHz band, which is a resonant frequency of antenna element 116.

Antenna element 116 has an electrical length of an approximately ¼ wavelength in the 2 GHz band, and resonates in the 2 GHz band in both an open state and a closed state. Filter 501 then blocks the 2 GHz band, so that the electrical connection between antenna element 116 and first hinge section 104 is blocked. As a result of this, when antenna element 116 resonates in the 2 GHz band, antenna element 116 alone functions as an antenna.

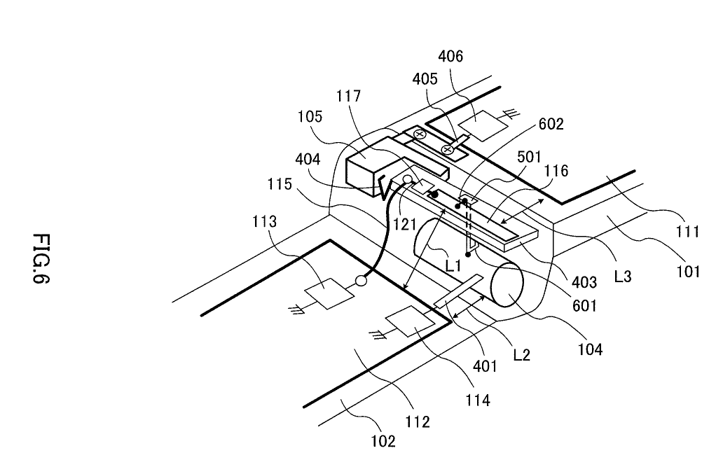

Next, the configuration of mobile radio device 500 will be described in more detail with reference to FIG. 6. FIG. 6 is a perspective view of principal parts of mobile radio device 500.

Mobile radio device 500 shown in FIG. 6 adds filter 501 and connecting section 602 to mobile radio device 100 of embodiment 1 shown in FIG. 4, and has connecting section 601 in place of connecting section 402. Parts in FIG. 6 that are the same as in FIG. 4 and FIG. 5 will be assigned the same reference numerals as in FIG. 4 and FIG. 5 and their explanations will be omitted.

Substrate 403 is formed of an insulating material, and, using an electrically conductive material, antenna element 116, matching circuit 117, filter 501 and connection section 602 are printed on an upper surface section. Also, substrate 403 has a throughhole (not shown) that penetrates from the upper surface section to the back surface section, and has a conductive layer in the inner wall part of the throughhole. This throughhole electrically connects filter 501 and connecting section 601.

Connecting section 601 is formed of an electrically conductive material that allows elastic deformation, and electrically connects filter 501 and first hinge section 104.

Connecting section 602 is formed of an electrically conductive material and electrically connects antenna element 116 and filter 501.

Like FIG. 4, with the present embodiment, antenna element 116 is provided such that L1>L2 and L3>L2. Also, although not shown in FIG. 4, antenna element 116 is placed such that distance L4 between first hinge section 104 and a ground section of circuit substrate 111 holds the relationship L1>L4 and L3>L4. By this means, compared to first hinge section 104, antenna element 116 is placed in a location substantially distant from both a ground section of circuit substrate 111 and a ground section of circuit substrate 112, so that it is possible to reduce the influence of both the ground section of circuit substrate 111 and the ground section of circuit substrate 112 upon antenna element 116.

Heretofore, to supply power to a hinge section directly and allow a hinge section to have a function to connect cases in a rotatable fashion, the shape has been limited, and, when forming a double-resonance antenna, it has been difficult to form an antenna to resonate at a desired frequency due to the hinge part.

In this way, with the present embodiment, to prevent a hinge section from resonating in the 2 GHz band, the 2 GHz band is blocked by means of a filter, and an antenna element that resonates in the 2 GHz band is placed distant from a ground section of a circuit substrate, so that it is possible to achieve high antenna performance in the 2 GHz band in both an open state and a closed state. Also, in the 800 MHz band, by supplying power to a hinge section via an antenna element, it is possible to allow a ground section of a circuit substrate provided in the first case, a hinge section, and a ground section of a circuit substrate provided in a second case function as a dipole antenna to resonate in the 800 MHz band, and achieve high antenna performance in the 800 MHz band in an open state. Also, the present embodiment makes it easy to change the length of antenna element, so that, by changing the length of an antenna element, it is possible to adjust a resonant frequency flexibly.

Although the present embodiment is configured to connect antenna element 116 and first hinge section 104 via filter 501, the present invention is by no means limited to this, and it is equally possible to connect antenna element 116 and first hinge section 104 via an arbitrary reactance element. For example, instead of filter 501, it is equally possible to use capacitance and coil circuit configurations that function as an arbitrary capacitor and an inductor in the 800 MHz band and in the 2 GHz band.

### Embodiment 3

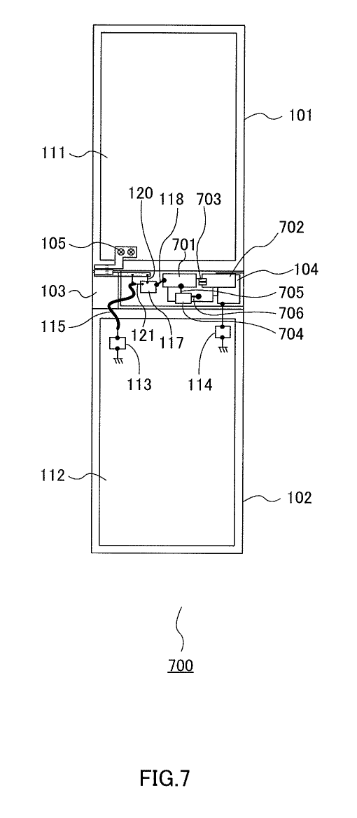

FIG. 7 is a plan view of mobile radio device 700 according to embodiment 3 of the present invention. FIG. 7 shows mobile radio device 700 in an open state.

Mobile radio device 700 shown in FIG. 7 adds filter 703, filter 704, connecting section 705 and connecting section 706, to mobile radio device 100 according to embodiment 1 shown in FIG. 1, except for connecting section 119, and has antenna element 701 and antenna element 702 instead of antenna element 116. Parts in FIG. 7 that are the same as in FIG. 1 will be assigned the same reference numerals as in FIG. 1 and their explanations will be omitted. Also, with mobile radio device 700 according to the present embodiment, the closed state is the same as shown in FIG. 2 and the state in which first case 101 rotates in a direction perpendicular to the rotation direction in FIG. 5 and is open, is the same as in FIG. 3, and their explanations therefore will be omitted.

Third case 103 accommodates first hinge section 104 and part of second hinge section 105 inside. Also, third case 103 accommodates antenna element 701, antenna element 702, matching circuit 117, filter 703 and filter 704 inside. Third case 103 also accommodates part of coaxial wire 115 inside.

Antenna element 701 is electrically connected with matching circuit 117 via connecting section 118. Antenna element 701 is fed power from power feed section 121 and functions as an antenna. Also, antenna element 701 is electrically connected with first hinge section 104 via filter 704. Antenna element 701 is also electrically connected with antenna element 702 via filter 703. Antenna element 701 is formed by, for example, printing an electrically conductive pattern on an insulating substrate. Antenna element 701 also has an electrical length to resonate, for example, in the 2 GHz band.

Filter 703 is, for example, a bandpass filter, and is formed with a reactance element. Filter 703 is electrically connected between antenna element 701 and antenna element 702, and, by this means, electrically connects antenna element 701 and antenna element 702. Also, filter 703 has low impedance in the 800 MHz band and has high impedance in the 2 GHz band, thereby blocking the 2 GHz band. That is to say, when antenna element 701 resonates in the 2 GHz band, filter 703 prevents antenna element 702 from functioning as an antenna.

Antenna element 702, including antenna element 701 and filter 703, has an electrical length to have an approximately ¼ wavelength in the 800 MHz. Antenna element 702 is also electrically connected with antenna element 701 via filter 703. Antenna element 702 is formed by, for example, printing an electrically conductive pattern on an insulating substrate.

Filter 704 is formed with a reactance element and is connected between antenna element 701 and first hinge section 104. Also, filter 704 is electrically connected with antenna element 701 by means of connecting section 705 and is also electrically connected with first hinge section 104 by means of connecting section 706, thereby electrically connecting first hinge section 104 and antenna element 701. Also, filter 704 has low impedance in the 800 MHz band and has high impedance in the 2 GHz band, thereby blocking the 2 GHz band. That is to say, when antenna element 701 resonates in the 2 GHz band, filter 704 prevents first hinge section 104 from functioning as an antenna.

In mobile radio device 700 having the above configuration, antenna element 701, filter 704, first hinge section 104, terminating end section 114, and a ground section of circuit substrate 112 are mutually electrically connected, and antenna element 701 is fed power from power feed section 121. By this means, in a state in which mobile radio device 700 is open, antenna element 701, filter 704, first hinge section 104, terminating end section 114, and a ground section of circuit substrate 112 function as an antenna of an approximately ¼ wavelength in the 800 MHz band. Also, in mobile radio device 700 having the above configuration, antenna element 701, filter 703, antenna element 702 are mutually electrically connected, and antenna element 701 is fed power from power feed section 121. By this means, in a state in which mobile radio device 700 is closed, antenna element 701, filter 703, and antenna element 702 function as an antenna of an approximately ¼ wavelength in the 800 MHz band. This antenna of an approximately ¼ wavelength configured this way resonates, for example, in the 800 MHz band.

Meanwhile, antenna element 701 functions as an antenna to resonate in the 2 GHz band in both an open state and a closed state. Filter 703 and filter 704 block the 2 GHz band, so that the electrical connection between antenna element 701 and first hinge section 104 is blocked and the electrical connection between antenna element 701 and antenna element 702 is blocked. As a result of this, when antenna element 701 resonates in the 2 GHz band, antenna element 701 alone functions as an antenna.

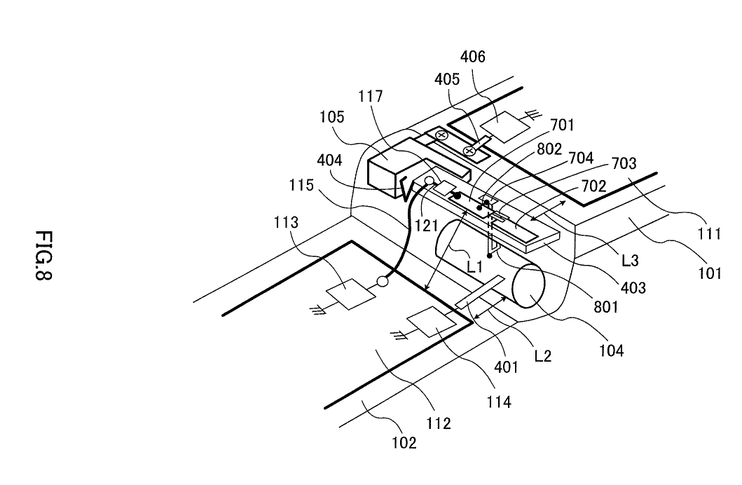

Next, the configuration of mobile radio device 700 will be described in more detail with reference to FIG. 8. FIG. 8 is a perspective view of principal parts of mobile radio device 700.

Mobile radio device 700 shown in FIG. 8 adds antenna element 701, antenna element 702, filter 703, filter 704, and connecting section 802, to mobile radio device 100 of embodiment 1 shown in FIG. 4, and has connecting section 801 instead of connecting section 402. Parts in FIG. 8 that are the same as in FIG. 4 and FIG. 7 will be assigned the same reference numerals as in FIG. 4 and FIG. 7 and their explanations will be omitted.

Substrate 403 is formed of an insulating material, and, using an electrically conductive material, antenna element 701, antenna element 702, matching circuit 117, filter 703, filter 704 and connection section 702, are printed on an upper surface section. Also, substrate 403 has a throughhole (not shown) that penetrates from the upper surface section to the back surface section, and has a conductive layer in the inner wall part of the throughhole. This throughhole electrically connects filter 704 and connecting section 801.

Connecting section 801 is formed of an electrically conductive material that allows elastic deformation, and electrically connects filter 704 and first hinge section 104.

Connecting section 802 is formed of an electrically conductive material and electrically connects antenna element 701 and filter 704.

Like FIG. 4, with the present embodiment, antenna element 701 and antenna element 702 are provided such that L1>L2 and L3>L2. Also, although not shown in FIG. 8, antenna element 701 and antenna element 702 are placed such that distance L4 between first hinge section 104 and a ground section of circuit substrate 111 holds the relationship L1>L4 and L3>L4. By this means, compared to first hinge section 104, antenna element 701 and antenna element 702 are placed in locations substantially distant from both a ground section of circuit substrate 111 and a ground section of circuit substrate 112, so that it is possible to reduce the influence of both the ground section of circuit substrate 111 and the ground section of circuit substrate 112 upon antenna element 701 and antenna element 702.

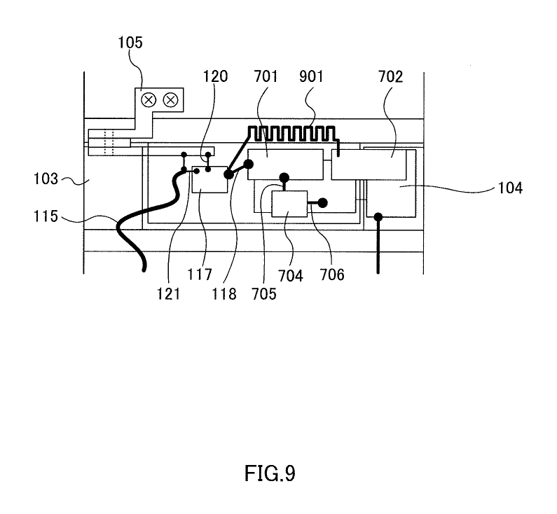

FIG. 9 provides another view of principal parts of mobile radio device 700. Parts in FIG. 9 that are the same as in FIG. 7 will be assigned the same reference numerals as in FIG. 7 and their explanations will be omitted.

FIG. 9 shows connecting section 901 in place of filter 703.

Connecting section 901 has a meander shape and electrically connects matching circuit 117 and antenna element 702. Also, connecting section 901 has low impedance in the 800 MHz band and has high impedance in the 2 GHz band, thereby blocking the 2 GHz band. That is to say, when antenna element 701 resonates in the 2 GHz band, connecting section 901 prevents antenna element 702 from functioning as an antenna.

By this means, with the present embodiment, by providing a double-resonant antenna element apart from a ground section of a circuit substrate, it is possible to achieve high antenna performance in both the 800 MHz band and 2 GHz band in a closed state. Also, in the 800 MHz band, by supplying power to a hinge section via an antenna element, it is possible to allow a ground section of a circuit substrate provided in the upper first case, a hinge section, and a ground section of a circuit substrate provided in a lower second case function as a dipole antenna to resonate in the 800 MHz band, and achieve high antenna performance in the 800 MHz band in an open state. Furthermore, to prevent a hinge section from resonating in the 2 GHz band, the 2 GHz band is blocked by means of a filter, and an antenna element that resonates in the 2 GHz band is placed distant from a ground section of a circuit substrate, so that it is possible to prevent antenna performance from deteriorating in the 2 GHz band. Also, the present embodiment makes it easy to change the length of antenna element, so that, by changing the length of an antenna element, it is possible to adjust two resonant frequencies flexibly.

Although the present embodiment is configured to connect antenna element 703 and first hinge section 104 via filter 704, the present invention is by no means limited to this, and it is equally possible to connect antenna element 703 and first hinge section 104 via an arbitrary reactance element. For example, instead of filter 704, it is equally possible to use capacitance and coil circuit configurations that function as an arbitrary capacitor and an inductor in the 800 MHz band and in the 2 GHz band.

### Embodiment 4

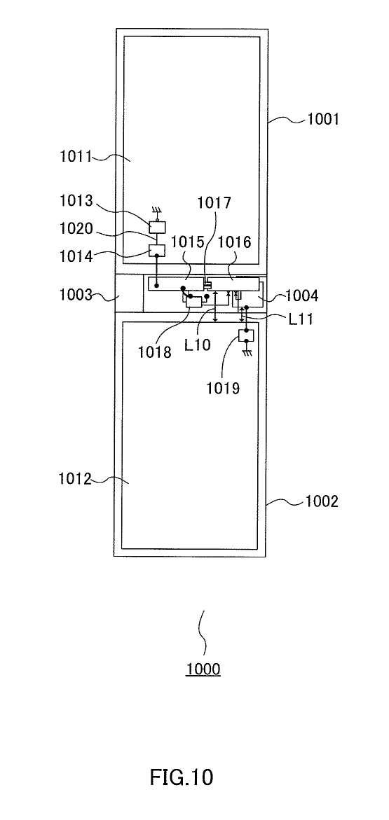

FIG. 10 is plan view showing mobile radio device 1000 according to embodiment 4 of the present invention.

FIG. 10 shows mobile radio device 1000 in an open state.

Mobile radio device 1000 has three cases: first case 1001, second case 1002, and third case 1003. Also, first case 1001, second case 1002 and third case 1003 are connected in a mutually rotatable fashion about hinge section 1004 as a rotation axis.

First case 1001 has a rectangular shape on a plan view, and is rotatably connected with second case 1002, via third case 1003, by means of hinge section 1004. Also, first case 1001 has circuit substrate 1011 inside. Also, first case 1001 has a display surface (not shown) that is exposed to the outside and displays an image when mobile radio device 1000 is open.

Second case 1002 has a rectangular shape on a plan view, and is rotatably connected with first case 1001, via third case 1003, by means of hinge section 1004. Also, second case 1002 has an operation surface (not shown) that is exposed to the outside and is operated during a call and so on, when mobile radio device 1000 is open. Second case 1002 furthermore has circuit substrate 1012 inside.

Third case 1003 has hinge section 1004. Also, third case 1003 has antenna element 1015, antenna element 1016, filter 1017, and filter 1018.

Hinge section 1004 is formed of an electrically conductive material, and connects first case 1001 and second case 1002 in a rotatable fashion, along the long direction of first case 1001 or second case 1002 (encompassing the upward or downward directions in FIG. 10), so as to switch from the open state shown in FIG. 10 to a closed state in which first case 1001 and second case 1002 overlap (not shown) or from the closed state to the open state of FIG. 10. Hinge section 1004 is furthermore electrically connected with antenna element 1016 and is also electrically connected with a ground section of circuit substrate 1012 via terminating end section 1019.

Circuit substrate 1011 has an electrically conductive circuit pattern (not shown) formed on a flat surface section, and has a ground section (not shown) over nearly the entire surface. Circuit substrate 1011 has radio circuit 1013 that is grounded in a ground section and matching circuit 1014. The ground section is formed by, for example, printing a ground pattern on circuit substrate 1011.

Circuit substrate 1012 has an electrically conductive circuit pattern (not shown) on a flat surface part, and has a ground section nearly over the entire surface (now shown). Circuit substrate 1012 also has terminating end section 1019. The ground section is formed by, for example, printing a ground pattern on circuit substrate 1012.

Radio circuit 1013 is grounded to a ground section of circuit substrate 1011 and is also electrically connected with matching circuit 1014. Also, radio circuit 113 performs receiving processing for a signal received by an antenna and performs transmitting processing for a signal to be transmitted from an antenna.

Matching circuit 1014 is electrically connected between radio circuit 1013 and antenna element 1015 and matches impedance between radio circuit 1013 and antenna element 1015.

Antenna element 1015 is electrically connected with matching circuit 1014. Antenna element 1015 is fed power from power feed section 1020 and functions as an antenna. Also, antenna element 1015 is electrically connected with antenna element 1016 via filter 1017. Antenna element 1015 is also electrically connected with hinge section 1004 via filter 1018. Antenna element 1015 also has an electrical length to resonate, for example, in the 2 GHz band. Antenna element 1015 is formed by, for example, printing an electrically conductive pattern on an insulating substrate.

Antenna element 1016, including antenna element 1015 and filter 1017, has an electrical length to have an approximately ¼ wavelength in the 800 MHz. Antenna element 1016 is also electrically connected with antenna element 1015 via filter 1017. Antenna element 1016 is formed by, for example, printing an electrically conductive pattern on an insulating substrate.

Filter 1017 is, for example, a bandpass filter, and is formed with a reactance element. Filter 1017 is electrically connected between antenna element 1015 and antenna element 1016, and, by this means, electrically connects antenna element 1015 and antenna element 1016. Also, filter 1017 has low impedance in the 800 MHz band and has high impedance in the 2 GHz band, thereby blocking the 2 GHz band. That is to say, when antenna element 1015 resonates in the 2 GHz band, filter 1017 prevents antenna element 1016 from functioning as an antenna.

Filter 1018 is formed with a reactance element, and is connected between antenna element 1015 and hinge section 1004. Also, filter 1018 is electrically connected with antenna element 1015 and is also electrically connected with hinge section 1004, thereby electrically connecting hinge section 1004 and antenna element 1015. Also, filter 1018 has low impedance in the 800 MHz band and has high impedance in the 2 GHz band, thereby blocking the 2 GHz band. That is to say, when antenna element 1015 resonates in the 2 GHz band, filter 1018 prevents hinge section 1004 from functioning as an antenna.

Terminating section 1019 is formed with a reactance element, and electrically connects a ground section of circuit substrate 1012 and hinge section 1004.

In mobile radio device 1000 having the above configuration, antenna element 1015, hinge section 1004, terminating end section 1019, and a ground section of circuit substrate 1012 are mutually electrically connected, and antenna element 1015 is fed power from power feed section 1020. By this means, in a state in which mobile radio device 1000 is open, antenna element 1015, filter 1018, hinge section 1004, terminating end section 1019, and a ground section of circuit substrate 1012 function as an antenna of an approximately ¼ wavelength in the 800 MHz band. Furthermore, in mobile radio device 1000, antenna element 1015, filter 1017, and antenna element 1016 are mutually electrically connected, and antenna element 1015 is fed power from power feed section 1020. By this means, in a state in which mobile radio device 1000 is closed, antenna element 1015, filter 1017, and antenna element 1016 function as an antenna of an approximately ¼ wavelength in the 800 MHz band. This antenna of an approximately ¼ wavelength configured this way resonates, for example, in the 800 MHz band.

Meanwhile, antenna element 1015 functions as an antenna to resonate in the 2 GHz band in both an open state and a closed state. Filter 1017 and filter 1018 then block the 2 GHz band, so that the electrical connection between antenna element 1015 and hinge section 1004 is blocked, and the electrical connection between antenna element 1015 and antenna element 1016 is blocked. As a result of this, when antenna element 1015 resonates in the 2 GHz band, antenna element 1015 alone functions as an antenna.

Distance L10 between antenna element 1015 and antenna element 1016 and a ground section of circuit substrate 1012 is made greater than distance L11 between hinge section 1004 and a ground section of circuit substrate 1012 (L10>L11) (see FIG. 10). Also, distance L12 between antenna element 1015 and antenna element 1016 and a ground section of circuit substrate 1011 is made greater than distance L13 between hinge section 1004 and a ground section of circuit substrate 1012 (L12>L13) (not shown). By this means, mobile radio device 1000 is able to alleviate the influence of a ground section of circuit substrate 1011 and a ground section of circuit substrate 1012 upon antenna element 1015 and antenna element 1016.

By this means, with the present embodiment, by providing double resonant antenna elements apart from a ground section of a circuit substrate, it is possible to achieve high antenna performance in both the 800 MHz band and 2 GHz band in a closed state. Also, in the 800 MHz band, by supplying power to a hinge section via an antenna element, it is possible to allow a ground section of a circuit substrate provided in the first case, a hinge section, and a ground section of a circuit substrate provided in a second case function as a dipole antenna to resonate in the 800 MHz band, and achieve high antenna performance in the 800 MHz band in an open state. Furthermore, to prevent a hinge section from resonating in the 2 GHz band, the 2 GHz band is blocked by means of a filter, and an antenna element that resonates in the 2 GHz band is placed distant from a ground section of a circuit substrate, so that it is possible to prevent antenna performance from deteriorating in the 2 GHz band. Also, with the present embodiment, for example, the length of an antenna element can be changed easily, so that, by adjusting an antenna element, it is possible to provide an antenna of better sensitivity.

Although a double-resonant antenna has been realized with the present embodiment, the present invention is by no means limited to this, and it is equally possible to present a single-resonant antenna. Also, although with the present embodiment an antenna element and a hinge section are electrically connected via a filter, the present invention is by no means limited to this, and it is equally possible to connect an antenna element and a hinge section electrically without involving a filter.

### Embodiment 5

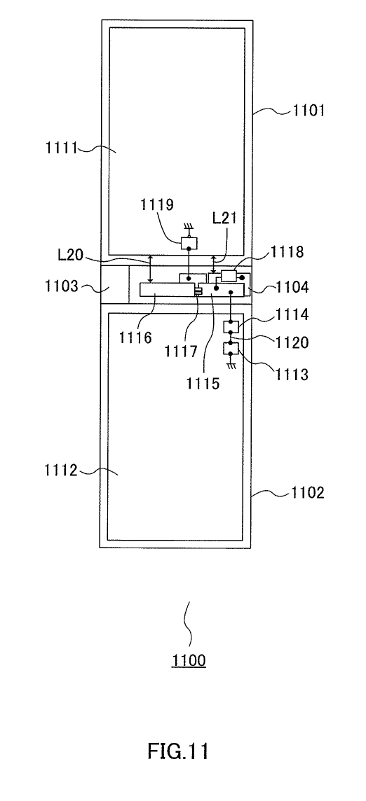

FIG. 11 is a plan view of mobile radio device 1100 according to embodiment 5 of the present invention. FIG. 11 shows mobile radio device 1100 in an open state.

Mobile radio device 1100 has three cases: first case 1101, second case 1102, and third case 1103. Also, first case 1101, second case 1102 and third case 1103 are connected in a mutually rotatable fashion about first hinge section 1104 as a rotation axis.

First case 1101 has a rectangular shape on a plan view, and is rotatably connected with second case 1102, via third case 1103, by means of hinge section 1104. Also, first case 1101 has circuit substrate 1111 inside. Also, first case 1101 has a display surface (not shown) that is exposed to the outside and displays an image when mobile radio device 1100 is open.

Second case 1102 has a rectangular shape on a plan view, and is rotatably connected with first case 1101, via third case 1103, by means of hinge section 1104. Also, second case 1102 has an operation surface (not shown) that is exposed to the outside and is operated during a call and so on, when mobile radio device 1100 is open. Second case 1102 has circuit substrate 1112 inside.

Third case 1103 accommodates hinge section 1104 inside. Third case 1103 accommodates antenna element 1115, antenna element 1116, filter 1117 and filter 1118 inside.

Hinge section 1104 is formed of an electrically conductive material, and connects first case 1101 and second case 1102 via third case 1103, in a rotatable fashion, along the long direction of first case 1101 or second case 1102 (encompassing the upward or downward directions in FIG. 11), so as to switch from the open state shown in FIG. 11 to a closed state in which first case 1101 and second case 1102 overlap (not shown) or from the closed state to the open state of FIG. 11. Hinge section 1104 is furthermore electrically connected with antenna element 1116 and is also electrically connected with a ground section of circuit substrate 1111 via terminating end section 1119.

Circuit substrate 1111 has an electrically conductive circuit pattern (not shown) on a flat surface part, and has a ground section nearly over the entire surface (now shown). Circuit substrate 1111 also has terminating end section 1119. The ground section is formed by, for example, printing a ground pattern on circuit substrate 1111.

Circuit substrate 1112 has an electrically conductive circuit pattern (not shown) on a flat surface part, and has a ground section nearly over the entire surface (now shown). Circuit substrate 1112 has radio circuit 1113 that is grounded in a ground section and matching circuit 1114. The ground section is formed by, for example, printing a ground pattern on circuit substrate 1112.

Radio circuit 1113 performs receiving processing for a signal received by an antenna and performs transmitting processing for a signal to be transmitted from an antenna.

Matching circuit 1114 is connected between radio circuit 1113 and antenna element 1115, and matches impedance between antenna element 1115 and radio circuit 1113.

Antenna element 1115 is electrically connected with matching circuit 1114. Also, antenna element 1115 is fed power from power feed section 1120 and functions as an antenna. Antenna element 1115 is also electrically connected with antenna element 1116 via filter 1117. Antenna element is also electrically connected with hinge section 1104 via filter 1118. Antenna element 1115 furthermore has an electrical length to resonate, for example, in the 2 GHz band.

Antenna element 1116, including antenna element 1115 and filter 1117, has an electrical length to have an approximately ¼ wavelength in the 800 MHz. Antenna element 1116 is also electrically connected with antenna element 1115 via filter 1117. Antenna element 1116 is formed by, for example, printing an electrically conductive pattern on an insulating substrate.

Filter 1117 is, for example, a bandpass filter, and is formed with a reactance element. Filter 1117 is electrically connected between antenna element 1115 and antenna element 1116, and, by this means, electrically connects antenna element 1115 and antenna element 1116. Also, filter 1117 has low impedance in the 800 MHz band and has high impedance in the 2 GHz band, thereby blocking the 2 GHz band. That is to say, when antenna element 1115 resonates in the 2 GHz band, filter 1117 prevents antenna element 1116 from functioning as an antenna.

Filter 1118 is formed with a reactance element and is connected between antenna element 1115 and hinge section 1104. Also, filter 1118 is electrically connected with antenna element 1115 and is also electrically connected with hinge section 1104, thereby electrically connecting hinge section 1104 and antenna element 1115. Also, filter 1118 has low impedance in the 800 MHz band and has high impedance in the 2 GHz band, thereby blocking the 2 GHz band. That is to say, when antenna element 1115 resonates in the 2 GHz band, filter 1118 prevents hinge section 1104 from functioning as an antenna.

Terminating end section 1119 is formed with a reactance element and electrically connects a ground section of circuit substrate 1112 and hinge section 1104.

In mobile radio device 1100 having the above configuration, antenna element 1115, filter section 1118, hinge section 1104, terminating end section 1119 and a ground section of circuit substrate 1111 are mutually electrically connected, and antenna element 1115 is fed power from power feed section 1120. By this means, in a state in which mobile radio device 1100 is open, antenna element 1115, filter 1118, hinge section 1104, terminating end section 1119, and a ground section of circuit substrate 1111 function as an antenna of an approximately ¼ wavelength in the 800 MHz band. In mobile radio device 1100 having the above configuration, antenna element 1115, filter 1117 and antenna element 1116 are mutually electrically connected, and antenna element 1115 is fed power from power feed section 1120. By this means, in a state in which mobile radio device 1100 is closed, antenna element 1115, filter 1117, and antenna element 1116 function as an antenna of an approximately ¼ wavelength in the 800 MHz band. This antenna of an approximately ¼ wavelength configured this way resonates, for example, in the 800 MHz band.

Meanwhile, antenna element 1115 functions as an antenna to resonate in the 2 GHz band in both an open state and a closed state. Filter 1117 and filter 1118 then block the 2 GHz band, so that the electrical connection between antenna element 1115 and hinge section 1104 is blocked and the electrical connection between antenna element 1115 and antenna element 1116 is blocked. As a result of this, when antenna element 1115 resonates in the 2 GHz band, antenna element 1115 alone functions as an antenna.

Distance L20 between antenna element 1115 and antenna element 1116 and a ground section of circuit substrate 1111 is made greater than distance L21 between hinge section 1104 and a ground section of circuit substrate 1111 (L20>L21) (see FIG. 11). Also, distance L22 between antenna element 1115 and antenna element 1116 and a ground section of circuit substrate 1112 is made greater than distance L23 between hinge section 1104 and a ground section of circuit substrate 1112 (L22>L23) (not shown). By this means, mobile radio device 1100 is able to alleviate the influence of a ground section of circuit substrate 1111 and a ground section of circuit substrate 1112 upon antenna element 1115 and antenna element 1116.

By this means, with the present embodiment, by providing double resonant antenna elements apart from a ground section of a circuit substrate, it is possible to achieve high antenna performance in both the 800 MHz band and 2 GHz band in a closed state. Also, in the 800 MHz band, by supplying power to a hinge section via an antenna element, it is possible to allow a ground section of a circuit substrate provided in the first case, a hinge section, and a ground section of a circuit substrate provided in a second case function as a dipole antenna to resonate in the 800 MHz band, and achieve high antenna performance in the 800 MHz band in an open state. Furthermore, to prevent a hinge section from resonating in the 2 GHz band, the 2 GHz band is blocked by means of a filter, and an antenna element that resonates in the 2 GHz band is placed distant from a ground section of a circuit substrate, so that it is possible to prevent antenna performance from deteriorating in the 2 GHz band. Also, with the present embodiment, for example, the length of an antenna element can be changed easily, so that, by adjusting an antenna element, it is possible to provide an antenna of better sensitivity.

Although a double-resonant antenna has been realized with the present embodiment, the present invention is by no means limited to this, and it is equally possible to present a single-resonant antenna. Also, although with the present embodiment an antenna element and a hinge section are electrically connected via a filter, the present invention is by no means limited to this, and it is equally possible to connect an antenna element and a hinge section electrically without involving a filter.

Although with above embodiment 1 to embodiment 5 an antenna element has been printed on a substrate, the present invention is by no means limited to this, and it is equally possible to process an electrically conductive material, without printing on a substrate. Also, although with above embodiment 1 to embodiment 5 an antenna has been configured to have an electrical length of an approximately ¼ wavelength, the present invention is by no means limited to this, and it is equally possible to form an antenna to have a different electrical length from ¼ wavelength. Furthermore, although with above embodiment 1 to embodiment 5 an antenna has been described to resonate at 800 MHz or 2 GHz, the present invention is by no means limited to this, and it is equally possible to set an arbitrary antenna resonant frequency by changing the electrical length of an antenna element.

The disclosure of Japanese Patent Application No. 200-280332, filed on Oct. 30, 2008, including the specification, drawings and abstract, is incorporated herein by its entirety.

### INDUSTRIAL APPLICABILITY

The present invention is particularly suitable for use with a radio device that has cases that can be opened and closed.

1. A mobile radio device comprising:
a first case having a first circuit substrate;
a second case having a second circuit substrate;
a hinge section that is electrically conductive and that connects the first case and the second case in a rotatable fashion;
an antenna element;
a radio circuit that is provided in the first circuit substrate or in the second circuit substrate; and
a power feed section that is electrically connected with the radio circuit and that feeds power to the antenna element,
wherein the hinge section is electrically connected with the power feed section via the antenna element.

2. The mobile radio device according to claim 1, wherein the first circuit substrate or the second circuit substrate and the hinge section are electrically connected via a reactance element.

3. The mobile radio device according to claim 1, further comprising a filter that is inserted between the antenna element and the hinge section and that blocks a resonant frequency of the antenna element.

4. The mobile radio device according to claim 3, wherein:
the antenna element comprises a first element that resonate at a first resonant frequency and a second element that is electrically connected with the first element and that resonates at a second resonant frequency, which is a higher frequency than the first resonant frequency; and
the filter is inserted between the second element and the hinge section and blocks the second resonant frequency.

5. The radio device according to claim 3, wherein the antenna element resonates at a first resonant frequency with the hinge section and a ground section of the second circuit substrate, and resonates at the second resonant frequency, which is a higher frequency than the first resonant frequency, when the second resonant frequency is blocked by the filter.

6. The mobile radio device according to claim 1, wherein the antenna element is provided such that a distance from ground sections of the first circuit substrate and the second circuit substrate to the antenna element is greater than a distance from the ground sections of the first circuit substrate and the second circuit substrate to the hinge section.

7. The mobile radio device according to claim 1, further comprising a matching circuit that matches impedance between the antenna element and the power feed section, wherein:
the hinge section has a first hinge section that rotates the first case and the second case in a long direction of the first case or the second case, and a second hinge section that rotates the first case and the second case in a different direction from the long direction;
the first hinge section is electrically connected with the antenna element; and
the second hinge section is electrically connected with a ground section of the matching circuit.
